(19) United States
(12) Patent Application Publication
(10) Pub. No.: US 2023/0254865 A1
(43) Pub. Date: Aug. 10, 2023

(54) A METHOD FOR DECODING SHORT PHYSICAL UPLINK CONTROL CHANNEL

(71) Applicant: Telefonaktiebolaget LM Ericsson (publ), Stockholm (SE)

(72) Inventors: Namir LIDIAN, SOLNA (SE); Sairamesh NAMMI, KISTA (SE); Yi-Ju CHEN, SOLNA (SE)

(21) Appl. No.: 18/015,097

(22) PCT Filed: Jul. 15, 2020
(86) PCT No.: PCT/SE2020/050737

§ 371 Date: Jan. 9, 2023

(51) Int. Cl. H04W 72/21; H04L 1/1812; H04W 72/541

(52) U.S. Cl. CPC H04W 72/21; H04L 1/1812; H04W 72/541

(57) ABSTRACT

Apparatuses and methods for decoding short physical uplink control channel for. In one embodiment, a method implemented in a network node includes determining whether to use one of a coherent detection and a non-coherent detection of a physical uplink control channel, PUCCH, based at least in part on information relating to the wireless device; configuring the wireless device with a first sequence and a second sequence for a hybrid automatic repeat request, HARQ, acknowledgement information on the PUCCH based at least in part on the determination of the one of the coherent detection and the non-coherent detection, the first sequence corresponding to a HARQ acknowledgement, HARQ-ACK, and the second sequence corresponding to a HARQ non-acknowledgement, HARQ-NACK; and receiving the HARQ acknowledgement information on the PUCCH according to the first sequence and the second sequence.

### TECHNICAL FIELD

The present disclosure relates to wireless communication and in particular, to arrangements for decoding short physical uplink control channel.

### BACKGROUND

The Third Generation Partnership Project (3GPP) project has specified 3GPP 5^{th} Generation (5G), also called 3GPP New Radio (NR) access to meet the huge demand for data centric applications. Below is an example list of some requirements that have been considered for 5G networks:
Data rates of several tens of megabits per second may be supported for tens of thousands of users;
1 gigabit per second to be offered simultaneously to tens of workers on a same office floor;
Several hundreds of thousands of simultaneous connections to be supported for massive sensor deployments;
Spectral efficiency may be significantly enhanced compared to 4G;
Coverage may be improved:
Signaling efficiency may be enhanced; and
Latency may be reduced significantly as compared to 3GPP Long Term Evolution (LTE).

From a services aspect, the NR specification may support at least the following three services:
Enhanced Mobile Broadband (eMBB): This is for high broadband applications where the data rate is a main criteria;
URLLC: This is for ultra-reliable communications where the packet error rate of 10\hat{ }(−6) may be required with less delay; and
Massive machine-type communication (mMTC): This is for connecting machine type of communications, where the number of devices is a main criteria.

Message Sequence Chart for Downlink Data Transfer

FIG. 1 shows an example of a typical message sequence for downlink data transfer in 5G systems. From the pilot or reference signals sent by the network node to the WD in step 1, the WD computes the channel estimates and then computes the parameters to be used for the channel state information (CSI) reporting in step 2. The CSI report includes for example channel quality indicator (CQI), precoding matrix index (PMI), rank information (RI), CSI reference signal (CSI-RS) Resource Indicator (CRI or beam indicator), etc.

The CSI report is sent to the network node via a feedback channel in step 3, either upon request from the network node (i.e., aperiodically), or the WD is configured to report CSI periodically. The network node's scheduler uses this information in choosing the parameters for scheduling of this particular WD in step 4. The network node then sends the scheduling parameters to the WD in a downlink control channel in step 5. Next, the actual data transfer takes place from the network node to the WD in step 6.

Downlink Reference Signals

Downlink reference signals may be predefined signals occupying specific resource elements (REs) within a downlink time-frequency grid. There may be several types of downlink reference signals that are transmitted in different ways to the WD and used for different purposes by the receiving terminal (WD). The following are examples:
CSI reference signals (CSI-RS): These reference signals may be used by WDs to acquire channel state information (CSI) and/or beam specific information (e.g., beam reference signal received power (RSRP)). In 5G, CSI-RS is WD specific; thus, it may have a significantly lower time-frequency density.
Demodulation reference signals (DMRS): These reference signals also sometimes referred to as WD-specific reference signals, may be used by terminals for channel estimation for the data channel. The label “WD-specific” relates to the fact that each demodulation reference signal is intended for channel estimation by a single terminal. That specific reference signal is then only transmitted within the resource blocks assigned for data traffic channel transmission to that terminal.

Uplink Control Channel

The uplink control channel carries information about Hybrid Automatic Repeat reQuest Acknowledgement (HARQ-ACK) information corresponding to the downlink data transmission, scheduling requests (SR) indicating that a WD is requesting uplink resources for a physical uplink shared channel (PUSCH) transmission and channel state information. The channel state information typically includes Open System Interconnection (OSI) Layer 1 Reference Signal Received Power (L1-RSRP), CRI, RI, CQI, and PMI.

Downlink Control Channel (DCI)

The physical downlink control channel (PDCCH) carries information about the scheduling grants. Typically, this includes a number of multiple-input multiple-output (MIMO) layers scheduled, transport block sizes (TBS), modulation for each codeword (CW), parameters related to HARQ, sub-band locations and also precoding matrix indicators (PMI) corresponding to the sub-bands. Note that, all DCI formats may not use and/or transmit all the information as discussed above; in general the contents of PDCCH depend on transmission mode and DCI format.

PUCCH Formats in NR

3GPP NR defines 5 PUCCH formats for reporting HARQ-ACK, SR and CSI. Table 1 summarizes at least some of the characteristics of each PUCCH format. Formats 1 and 2 are generally only used for sending HARQ-ACK. Long PUCCH formats are generally used for HARQ-ACK, CSI. PUCCH format 0 may be considered a short PUCCH format.

TABLE 1
PUCCH Formats in NR

| Format | Alternative | Symbol | | |
|---|---|---|---|---|
| Name | name | length | Waveform | Information |
| Format 0 | Short PUCCH <= | 1-2 | CP-OFDM | HARQ-ACK, |
| | 2 bits | | | SR |
| Format 1 | Long PUCCH <= | 4-14 | CP-OFDM | HARQ-ACK, |
| | 2 bits | | | SR |
| Format 2 | Short PUCCH > | 1-2 | CP-OFDM | HARQ-ACK, |
| | 2 bits | | | CSI |
| Format 3 | Long PUCCH > | 4-14 | DFT-s-OFDM | HARQ-ACK, |
| | 2 bits | | | CSI |
| Format 4 | Long PUCCH > | 4-14 | DFT-s-OFDM | HARQ-ACK, |
| | 2 bits | | | CSI |

### SUMMARY

Some embodiments advantageously provide a method and system for decoding short physical uplink control channel for e.g., Ultra-Reliable Low Latency Communication (URLLC).

According to an aspect of the present disclosure, a method implemented in a network node for detection of a signal received from a wireless device is provided. The method includes determining whether to use one of a coherent detection and a non-coherent detection of a physical uplink control channel, PUCCH, based at least in part on information relating to the wireless device. The method includes configuring the wireless device with a first sequence and a second sequence for a hybrid automatic repeat request, HARQ, acknowledgement information on the PUCCH based at least in part on the determination of the one of the coherent detection and the non-coherent detection, the first sequence corresponding to a HARQ acknowledgement, HARQ-ACK, and the second sequence corresponding to a HARQ non-acknowledgement, HARQ-NACK. The method includes receiving the HARQ acknowledgement information on the PUCCH according to the first sequence and the second sequence.

In some embodiments of this aspect, when the determining comprises determining to use the coherent detection of the PUCCH based at least in part on the information relating to the wireless device, configuring the wireless device with the first sequence and the second sequence comprises: configuring the wireless device with the first sequence and the second sequence as partially overlapping sequences. In some embodiments of this aspect, when the determining comprises determining to use the coherent detection of the PUCCH based at least in part on the information relating to the wireless device, the receiving comprises: estimating a part of the PUCCH in which the first sequence partially overlaps with the second sequence and using the channel estimation to decode the HARQ acknowledgement information on the PUCCH. In some embodiments of this aspect, when the determining comprises determining to use the coherent detection of the PUCCH based at least in part on the information relating to the wireless device, the receiving comprises: estimating the PUCCH based on an overlap of the first sequence and the second sequence and interpolating the channel estimation to at least one resource element in which the first sequence and the second sequence do not overlap.

In some embodiments of this aspect, when the determining comprises determining to use the non-coherent detection of the PUCCH based at least in part on the information relating to the wireless device, the receiving comprises: correlating the received HARQ acknowledgment information to the first sequence and the second sequence to determine whether the HARQ acknowledgment information is a HARQ acknowledgement, ACK, corresponding to the first sequence or a HARQ non-acknowledgement, NACK, corresponding to the second sequence. In some embodiments of this aspect, the configuration of the wireless device with the first sequence and the second sequence is a configuration of the PUCCH with a physical uplink control channel format 0. In some embodiments of this aspect, the configuring of the wireless device includes configuring the wireless device via radio resource control, RRC, signaling.

In some embodiments of this aspect, the determining whether to use the one of the coherent detection and the non-coherent detection of the PUCCH based at least in part on the information about the wireless device comprises: determining whether to use the one of the coherent detection and the non-coherent detection of the PUCCH based at least in part on a type of service associated with the wireless device. In some embodiments of this aspect, the type of service corresponds to a type of service for a downlink channel and the HARQ acknowledgement information one of acknowledges and non-acknowledges successful reception of the downlink channel. In some embodiments of this aspect, the type of service is at least one of an Ultra Reliable Low Latency Communication, URLLC, an enhanced mobile broadband, eMBB, and a massive machine type communication, mMTC; when the type of service is the URLLC, determining to use the coherent detection for the wireless device; and when the type of service is one of the eMBB and the mMTC, determining to use the non-coherent detection for the wireless device.

In some embodiments of this aspect, the determining to use one of the coherent detection and the non-coherent detection of the PUCCH based at least in part on the information about the wireless device comprises: determining whether to use the one of the coherent detection and the non-coherent detection of the PUCCH based at least in part on a location of the wireless device within a cell supported by the network node relative to a location of the network node. In some embodiments of this aspect, the determining to use one of the coherent detection and the non-coherent detection of the PUCCH based at least in part on the information about the wireless device comprises: determining whether to use the one of the coherent detection and the non-coherent detection of the PUCCH based at least in part on a geometry associated with the wireless device. In some embodiments of this aspect, the determining to use the one of the coherent detection and the non-coherent detection of the PUCCH based at least in part on the information about the wireless device comprises: determining whether to use the one of the coherent detection and the non-coherent detection of the PUCCH based at least in part on a signal-to-interference-plus-noise-ratio, SINR, associated with the wireless device over a period of time. In some embodiments of this aspect, the determining whether to use the one of the coherent detection and the non-coherent detection of the PUCCH based at least in part on the information about the wireless device comprises: determining whether to use the one of the coherent detection and the non-coherent detection of the PUCCH based at least in part on a path loss associated with the wireless device to the network node.

In some embodiments of this aspect, the method further includes transmitting a downlink data channel to the wireless device. The HARQ acknowledgement information one of acknowledges and non-acknowledges successful reception of the downlink data channel based on whether the HARQ acknowledgement information uses the first sequence or the second sequence. In some embodiments of this aspect, the first sequence and the second sequence are constant amplitude zero autocorrelation, CAZAC, complex value symbols.

According to another aspect of the present disclosure, a method implemented in a wireless device configured to communicate with a network node is provided. The method includes receiving a configuration of a first sequence and a second sequence for a hybrid automatic repeat request, HARQ, acknowledgement information on a physical uplink control channel, PUCCH, the configuration of the first sequence and the second sequence being based at least in part on a determination of whether to use one of a coherent detection and a non-coherent detection of the PUCCH, the first sequence corresponding to a HARQ acknowledgement, HARQ-ACK, and the second sequence corresponds to a HARQ non-acknowledgement, HARQ-NACK. The method includes sending the HARQ acknowledgement information on the PUCCH according to the configuration of the first sequence and the second sequence.

In some embodiments of this aspect, when the determination is to use the coherent detection of the PUCCH, receiving the configuration of the first sequence and the second sequence comprises: receiving the configuration having the first sequence and the second sequence as partially overlapping sequences. In some embodiments of this aspect, when the determination is to use the coherent detection of the PUCCH, the sending comprises: sending the HARQ acknowledgement information on the PUCCH, a part of the PUCCH in which the first sequence overlaps with the second sequence corresponding to a reference signal to be used to estimate the PUCCH for decoding the HARQ acknowledgement information. In some embodiments of this aspect, the configuration of the first sequence and the second sequence is a configuration of the PUCCH with a physical uplink control channel format 0. In some embodiments of this aspect, the configuration of the first sequence and the second sequence is performed via radio resource control, RRC, signaling.

In some embodiments of this aspect, the determination of whether to use the one of the coherent detection and the non-coherent detection of the PUCCH is based at least in part on information about the wireless device. In some embodiments of this aspect, the information includes a type of service associated with the wireless device. In some embodiments of this aspect, the type of service corresponds to a type of service for a downlink channel and the HARQ acknowledgement information one of acknowledges and non-acknowledges successful reception of the downlink channel. In some embodiments of this aspect, the type of service is at least one of an Ultra Reliable Low Latency Communication, URLLC, an enhanced mobile broadband, eMBB, and a massive machine type communication, mMTC. In some embodiments of this aspect, when the type of service is the URLLC, the configuration of the first sequence and the second sequence is for coherent detection; and when the type of service is one of the eMBB and mMTC, the configuration of the first sequence and the second sequence is for non-coherent detection.

In some embodiments of this aspect, the information includes a location of the wireless device within a cell supported by the network node relative to a location of the network node. In some embodiments of this aspect, the information includes a geometry associated with the wireless device. In some embodiments of this aspect, the information includes a signal-to-interference-plus-noise-ratio, SINR, associated with the wireless device over a period of time. In some embodiments of this aspect, the information includes a path loss associated with the wireless device to the network node. In some embodiments of this aspect, the method further includes receiving a downlink data channel; and the HARQ acknowledgment information one of acknowledges and non-acknowledges successful reception of the downlink data channel based on whether the HARQ acknowledgment information uses the first sequence or the second sequence. In some embodiments of this aspect, the first sequence and the second sequence are constant amplitude zero autocorrelation, CAZAC, complex value symbols.

According to another aspect of the present disclosure, a network node for detection of a signal received from a wireless device is provided. The network node includes processing circuitry. The processing circuitry is configured to cause the network node to determine whether to use one of a coherent detection and a non-coherent detection of a physical uplink control channel, PUCCH, based at least in part on information relating to the wireless device. The processing circuitry is configured to cause the network node to configure the wireless device with a first sequence and a second sequence for a hybrid automatic repeat request, HARQ, acknowledgement information on the PUCCH based at least in part on the determination of the one of the coherent detection and the non-coherent detection, the first sequence corresponding to a HARQ acknowledgement, HARQ-ACK, and the second sequence corresponding to a HARQ non-acknowledgement, HARQ-NACK. The processing circuitry is configured to cause the network node to receive the HARQ acknowledgement information on the PUCCH according to the first sequence and the second sequence.

In some embodiments of this aspect, the processing circuitry is configured to cause the network node to configure the wireless device with the first sequence and the second sequence by being configured to cause the network node to: when the network node to determines to use the coherent detection of the PUCCH, configure the wireless device with the first sequence and the second sequence as partially overlapping sequences. In some embodiments of this aspect, the processing circuitry is configured to cause the network node to receive by being configured to cause the network node to: when the network node determines to use the coherent detection of the PUCCH, estimate a part of the PUCCH in which the first sequence partially overlaps with the second sequence and use the channel estimation to decode the HARQ acknowledgement information on the PUCCH.

In some embodiments of this aspect, the processing circuitry is configured to cause the network node to receive by being configured to cause the network node to: when the network node determines to use the coherent detection of the PUCCH, estimate the PUCCH based on an overlap of the first sequence and the second sequence and interpolate the channel estimation to at least one resource element in which the first sequence and the second sequence do not overlap. In some embodiments of this aspect, the processing circuitry is configured to cause the network node to receive by being configured to cause the network node to: when the network node determines to use the non-coherent detection of the PUCCH, correlate the received HARQ acknowledgment information to the first sequence and the second sequence to determine whether the HARQ acknowledgment information is a HARQ acknowledgement, ACK, corresponding to the first sequence or a HARQ non-acknowledgement, NACK, corresponding to the second sequence.

In some embodiments of this aspect, the configuration of the wireless device with the first sequence and the second sequence is a configuration of the PUCCH with a physical uplink control channel format 0. In some embodiments of this aspect, the processing circuitry is configured to cause the network node to configure the wireless device by being configured to cause the network node to: configure the wireless device via radio resource control, RRC, signaling. In some embodiments of this aspect, the processing circuitry is configured to cause the network node to determine whether to use the one of the coherent detection and the non-coherent detection of the PUCCH by being configured to cause the network node to: determine whether to use the one of the coherent detection and the non-coherent detection of the PUCCH based at least in part on a type of service associated with the wireless device. In some embodiments of this aspect, the type of service corresponds to a type of service for a downlink channel and the HARQ acknowledgement information one of acknowledges and non-acknowledges successful reception of the downlink channel.

In some embodiments of this aspect, the type of service is at least one of an Ultra Reliable Low Latency Communication, URLLC, an enhanced mobile broadband, eMBB, and a massive machine type communication, mMTC. In some embodiments of this aspect, the processing circuitry is configured to cause the network node to: when the type of service is the URLLC, determine to use the coherent detection for the wireless device; and when the type of service is one of the eMBB and the mMTC, determine to use the non-coherent detection for the wireless device. In some embodiments of this aspect, the processing circuitry is configured to cause the network node to determine to use one of the coherent detection and the non-coherent detection of the PUCCH by being configured to cause the network node to: determine whether to use the one of the coherent detection and the non-coherent detection of the PUCCH based at least in part on a location of the wireless device within a cell supported by the network node relative to a location of the network node. In some embodiments of this aspect, the processing circuitry is configured to cause the network node to determine to use one of the coherent detection and the non-coherent detection of the PUCCH by being configured to cause the network node to: determine whether to use the one of the coherent detection and the non-coherent detection of the PUCCH based at least in part on a geometry associated with the wireless device.

In some embodiments of this aspect, the processing circuitry is configured to cause the network node to determine to use one of the coherent detection and the non-coherent detection of the PUCCH by being configured to cause the network node to: determine whether to use the one of the coherent detection and the non-coherent detection of the PUCCH based at least in part on a signal-to-interference-plus-noise-ratio, SINR, associated with the wireless device over a period of time. In some embodiments of this aspect, the processing circuitry is configured to cause the network node to determine to use one of the coherent detection and the non-coherent detection of the PUCCH by being configured to cause the network node to: determine whether to use the one of the coherent detection and the non-coherent detection of the PUCCH based at least in part on a path loss associated with the wireless device to the network node.

In some embodiments of this aspect, the processing circuitry is further configured to cause the wireless device to transmit a downlink data channel to the wireless device; and the HARQ acknowledgement information one of acknowledges and non-acknowledges successful reception of the downlink data channel based on whether the HARQ acknowledgement information uses the first sequence or the second sequence. In some embodiments of this aspect, the first sequence and the second sequence are constant amplitude zero autocorrelation, CAZAC, complex value symbols.

According to yet another aspect of the present disclosure, a wireless device configured to communicate with a network node is provided. The wireless device includes processing circuitry. The processing circuitry is configured to cause the wireless device to receive a configuration of a first sequence and a second sequence for a hybrid automatic repeat request, HARQ, acknowledgement information on a physical uplink control channel, PUCCH, the configuration of the first sequence and the second sequence being based at least in part on a determination of whether to use one of a coherent detection and a non-coherent detection of the PUCCH, the first sequence corresponding to a HARQ acknowledgement, HARQ-ACK, and the second sequence corresponds to a HARQ non-acknowledgement, HARQ-NACK. The processing circuitry is configured to cause the wireless device to send the HARQ acknowledgement information on the PUCCH according to the configuration of the first sequence and the second sequence.

In some embodiments of this aspect, the processing circuitry is configured to cause the wireless device to receive the configuration of the first sequence and the second sequence by being configured to cause the wireless device to: when the determination is to use the coherent detection of the PUCCH, receive the configuration having the first sequence and the second sequence as partially overlapping sequences. In some embodiments of this aspect, the processing circuitry is configured to cause the wireless device to send by being configured to cause the wireless device to: when the determination is to use the coherent detection of the PUCCH, send the HARQ acknowledgement information on the PUCCH, a part of the PUCCH in which the first sequence overlaps with the second sequence corresponding to a reference signal to be used to estimate the PUCCH for decoding the HARQ acknowledgement information.

In some embodiments of this aspect, the configuration of the first sequence and the second sequence is a configuration of the PUCCH with a physical uplink control channel format 0. In some embodiments of this aspect, the processing circuitry is configured to cause the wireless device to receive the configuration of the first sequence and the second sequence via radio resource control, RRC, signaling. In some embodiments of this aspect, the determination of whether to use the one of the coherent detection and the non-coherent detection of the PUCCH is based at least in part on information about the wireless device. In some embodiments of this aspect, the information includes a type of service associated with the wireless device. In some embodiments of this aspect, the type of service corresponds to a type of service for a downlink channel and the HARQ acknowledgement information one of acknowledges and non-acknowledges successful reception of the downlink channel.

In some embodiments of this aspect, the type of service is at least one of an Ultra Reliable Low Latency Communication, URLLC, an enhanced mobile broadband, eMBB, and a massive machine type communication, mMTC; when the type of service is the URLLC, the configuration of the first sequence and the second sequence is for coherent detection; and when the type of service is one of the eMBB and mMTC, the configuration of the first sequence and the second sequence is for non-coherent detection. In some embodiments of this aspect, the information includes a location of the wireless device within a cell supported by the network node relative to a location of the network node. In some embodiments of this aspect, the information includes a geometry associated with the wireless device. In some embodiments of this aspect, the information includes a signal-to-interference-plus-noise-ratio, SINR, associated with the wireless device over a period of time. In some embodiments of this aspect, the information includes a path loss associated with the wireless device to the network node.

In some embodiments of this aspect, the processing circuitry is further configured to cause the wireless device to receive a downlink data channel; and the HARQ acknowledgment information one of acknowledges and non-acknowledges successful reception of the downlink data channel based on whether the HARQ acknowledgment information uses the first sequence or the second sequence. In some embodiments of this aspect, the first sequence and the second sequence are constant amplitude zero autocorrelation, CAZAC, complex value symbols.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example message sequence between a network node and a wireless device;

FIG. 2 is a schematic diagram of an example network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating example methods implemented in a communication system including a host computer, a network node and a wireless device for executing a client application at a wireless device according to some embodiments of the present disclosure;

FIG. 5 is a flowchart illustrating example methods implemented in a communication system including a host computer, a network node and a wireless device for receiving user data at a wireless device according to some embodiments of the present disclosure;

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure;

FIG. 8 is a flowchart of an example process in a network node according to some embodiments of the present disclosure;

FIG. 9 is a flowchart of an example process in a wireless device according to some embodiments of the present disclosure;

FIG. 10 illustrates an example schematic diagram of a hybrid detection scheme according to some embodiments of the present disclosure; and

FIG. 11 illustrates an example block error rate (BLER) comparison between a non-coherent detection and a coherent detection, without demodulation reference signal (DMRS), according to some embodiments of the present disclosure.

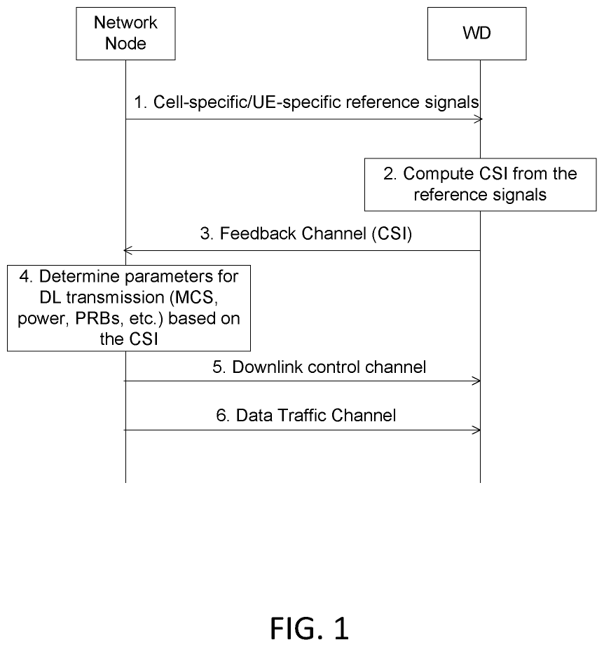

### DETAILED DESCRIPTION

Robust detection of PUCCH, such as PUCCH format 0, is key for a successful downlink data transmission. This may be because once the network node (e.g., gNodeB) decodes the uplink control channel, the network node determines whether the WD transmitted HARQ-ACK or HARQ negative-acknowledgement or non-acknowledgement (HARQ-NAK). Since the contents of PUCCH format 0 are not cyclic redundancy check (CRC) protected, a robust mechanism for the network node to determine HARQ-ACK or HARQ-NAK is particularly useful for such PUCCH formats. However, since the channel quality and interference generally vary randomly, there is always a possibility of a miss detection. That is, for example, if the WD sends a HARQ-ACK and the network node (e.g., gNodeB) detects it as a HARQ-NAK. Similarly, if the WD sends a HARQ-NAK and the network node (e.g., gNodeB) detects it as a HARQ-ACK. The consequence of probability of a miss detection is severe, especially for URLLC, because the network node may be required to take care of high reliable transmissions at the same time as low latency applications and within a specific time period.

For example, for sending HARQ-ACK using PUCCH format 0, the WD transmits one of the constant amplitude zero autocorrelation, CAZAC, sequences in the 3GPP Technical Specification (TS) for transmitting HARQ-ACK and another sequence for transmitting HARQ-NAK. Since there are reference symbols that are associated with PUCCH format 0, receivers generally use correlation between these sequences and determine whether the WD transmitted HARQ-ACK or HARQ-NAK for the corresponding physical downlink shared channel (PDSCH) transmission. The performance of correlation receivers is considered very poor and may not satisfy the requirements set for URLLC. Therefore, a new detection PUCCH mechanism is needed.

In some embodiments, the new mechanism may be a mechanism that does not introduce reference symbols and/or may be used for detecting a PUCCH format that does not use CRC and/or may be used for detecting a PUCCH format that uses sequences to determine whether the HARQ is an ACK or a NACK, such as PUCCH format 0.

Some embodiments of the present disclosure propose a hybrid detection scheme for decoding a PUCCH format, e.g., PUCCH format 0, where the hybrid detection scheme switches between a non-coherent detection and a coherent detection scheme (without adding additional DMRS symbols) for PUCCH format 0. In some embodiments, for high signal-to-noise (SNR) WDs, the network node detects PUCCH using a PUCCH receiver having a non-coherent detection scheme, while for low-medium SNR WDs the network node detects PUCCH using a PUCCH receiver having a coherent detection scheme (without adding additional DMRS symbols). Similarly, in some embodiments, for eMBB WDs, the network node can use non-coherent detection, while for URLLC WDs the network node uses a coherent detection scheme (without adding additional DMRS symbols). In some embodiments, the network node may be considered to have different PUCCH receivers for different types of WDs, e.g., an advanced receiver having coherent detection for URLLC WDs and a low complexity receiver having non-coherent detection for eMBB WDs.

In some embodiments of the proposed coherent detection scheme, the network configures the WD with sequences such that there is an overlap of symbols between the two hypothesis: HARQ-ACK and HARQ-NAK. Since some of the entries in the CAZAC sequence are common (i.e., overlapping) between these sequences, the network node can use these overlapping symbols to estimate the channel. Once the network node estimates the channel, the network node may use coherent detection to determine whether the WD transmitted HARQ-ACK or HARQ-NAK, which may improve the performance of the NR uplink control channel.

Some embodiments of the proposed solution may allow for a better detection capability for the uplink control channel, as compared to existing detection schemes, thereby achieving significant improvement of the block error rate (BLER) for PUCCH format 0.

Before describing in detail example embodiments, it is noted that the embodiments reside primarily in combinations of apparatus components and processing steps related to arrangements for decoding short physical uplink control channel. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

In some embodiments, the term “partially overlap” is used to indicate a part of a HARQ-ACK sequence and a part of a HARQ-NACK sequence that are the same, i.e., same complex value symbols. In some embodiments, such partially overlapping sequences may be used by the network node to estimate the channel to provide a more robust PUCCH detection for certain WDs, as compared to e.g., a correlation detection scheme.

In some embodiments, “coherent detection” may indicate detection of a channel that utilizes estimation of the channel.

In some embodiments, “non-coherent detection” may indicate detection of a channel that does not utilize estimation of the channel.

Although the description herein may be explained in the context of a PUCCH channel, it should be understood that the principles may also be applicable to other channels.

Even though the descriptions herein may be explained in the context of one of a Downlink (DL) and an Uplink (UL) communication, it should be understood that the basic principles disclosed may also be applicable to the other of the one of the DL and the UL communication. In some embodiments in this disclosure, the principles may be considered applicable to a transmitter and a receiver. For DL communication, the network node is the transmitter and the receiver is the WD. For the UL communication, the transmitter is the WD and the receiver is the network node.

Receiving information may comprise receiving one or more information messages (e.g., uplink control information, such as, HARQ information). It may be considered that receiving signaling comprises demodulating, decoding and/or other types of detecting, e.g., correlating, e.g. based on an assumed set of resources (e.g., PUCCH resources) and/or configuration information. In some embodiments it may be assumed that both sides of the communication are aware of the configurations, and/or the assumed set of resources.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

Generally, it may be considered that the network, e.g. a signaling radio node and/or node arrangement (e.g., network node), configures a WD, in particular with the transmission resources. A resource may in general be configured with one or more messages. Different resources may be configured with different messages, and/or with messages on different layers or layer combinations. The size of a resource may be represented in symbols and/or subcarriers and/or resource elements and/or physical resource blocks (depending on domain), and/or in number of bits it may carry, e.g. information or payload bits, or total number of bits. The set of resources, and/or the resources of the sets, may pertain to the same carrier and/or bandwidth part, and/or may be located in the same slot, or in neighboring slots.

Configuring a Radio Node

Configuring a radio node, in particular a terminal or user equipment or the WD, may refer to the radio node being adapted or caused or set and/or instructed to operate according to the configuration. Configuring may be done by another device, e.g., a network node (for example, a radio node of the network like a base station or gNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message's.

Configuring in General

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g. WD) may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor. In particular, configuring a terminal (e.g. WD) may comprise configuring the WD to perform certain measurements on certain subframes or radio resources and reporting such measurements according to embodiments of the present disclosure.

A resource element may represent a smallest time-frequency resource, e.g. representing the time and frequency range covered by one symbol or a number of bits represented in a common modulation. A resource element may e.g. cover a symbol time length and a subcarrier, in particular in 3GPP and/or LTE standards. A data transmission may represent and/or pertain to transmission of specific data, e.g. a specific block of data and/or transport block.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

A cell may be generally a communication cell, e.g., of a cellular or mobile communication network, provided by a node. A serving cell may be a cell on or via which a network node (the node providing or associated to the cell, e.g., base station or gNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE-standard or NR-standard. One or more carriers (e.g., uplink and/or downlink carrier/s and/or a carrier for both uplink and downlink) may be associated to a cell.

The term “radio measurement” used herein may refer to any measurement performed on radio signals. Radio measurements can be absolute or relative. Radio measurement may be called as signal level which may be signal quality and/or signal strength. Radio measurements can be e.g. intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide arrangements for decoding short physical uplink control channel for Ultra-Reliable Low Latency Communication (URLLC).

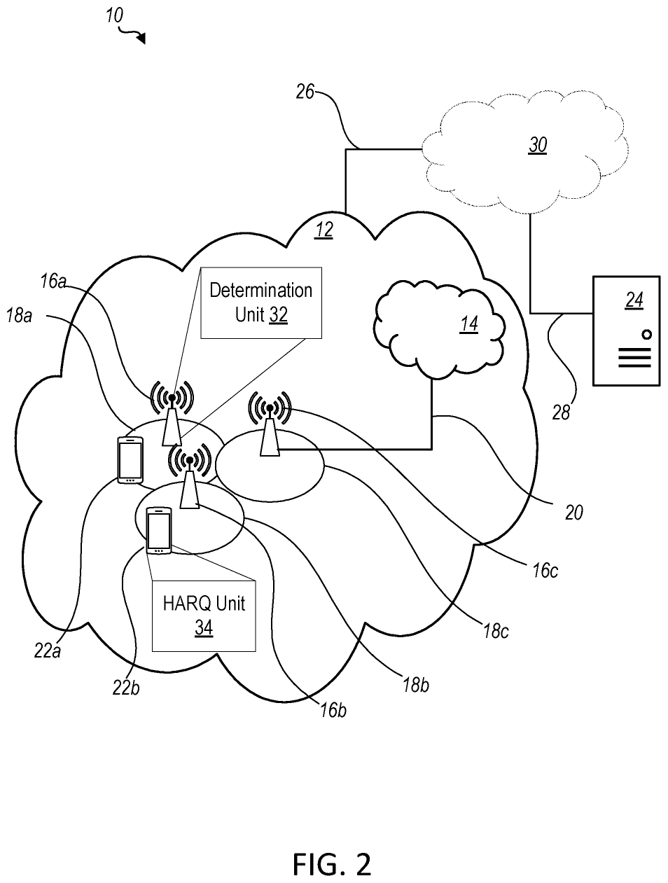

Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OT connection, using the access network 12, the core network 14, any intermediate network 30 and possible further infrastructure (not shown) as intermediaries. The OT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a determination unit 32 which is configured to determine whether to use one of a coherent detection and a non-coherent detection of a physical uplink control channel, PUCCH, based at least in part on information relating to the wireless device; configure the wireless device with a first sequence and a second sequence for a hybrid automatic repeat request, HARQ, acknowledgement information on the PUCCH based at least in part on the determination of the one of the coherent detection and the non-coherent detection, the first sequence corresponding to a HARQ acknowledgement, HARQ-ACK, and the second sequence corresponding to a HARQ non-acknowledgement, HARQ-NACK; and receive the HARQ acknowledgement information on the PUCCH according to the first sequence and the second sequence.

A wireless device 22 is configured to include a HARQ unit 34 which is configured to receive a configuration of a first sequence and a second sequence for a hybrid automatic repeat request, HARQ, acknowledgement information on a physical uplink control channel, PUCCH, the configuration of the first sequence and the second sequence being based at least in part on a determination of whether to use one of a coherent detection and a non-coherent detection of the PUCCH, the first sequence corresponding to a HARQ acknowledgement, HARQ-ACK, and the second sequence corresponds to a HARQ non-acknowledgement, HARQ-NACK; and send the HARQ acknowledgement information on the PUCCH according to the configuration of the first sequence and the second sequence.

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

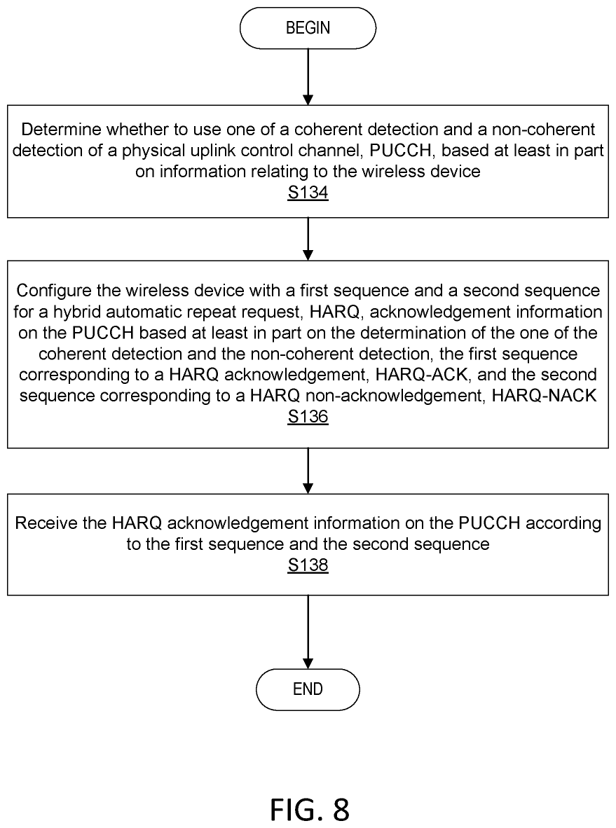

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include determination unit 32 configured to perform network node methods discussed herein, such as the methods discussed with reference to FIG. 8 as well as other figures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

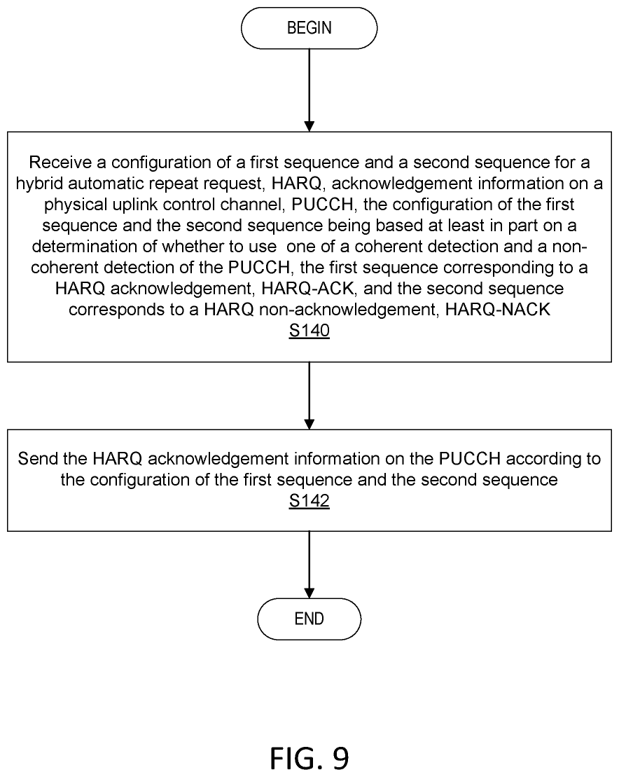

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a HARQ unit 34 configured to perform WD methods discussed herein, such as the methods discussed with reference to FIG. 9 as well as other figures.

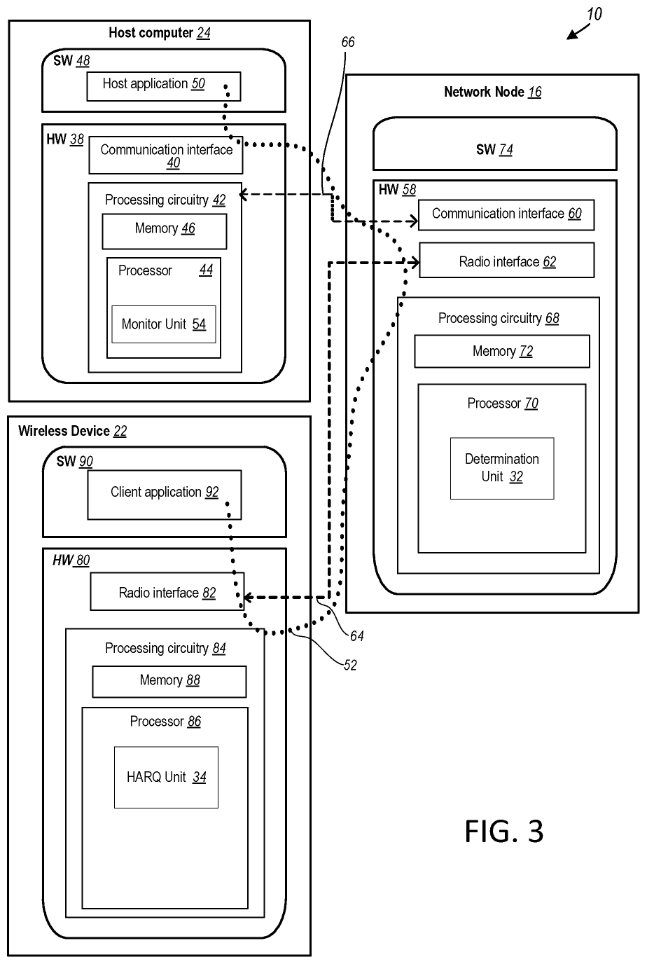

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as determination unit 32, and HARQ unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

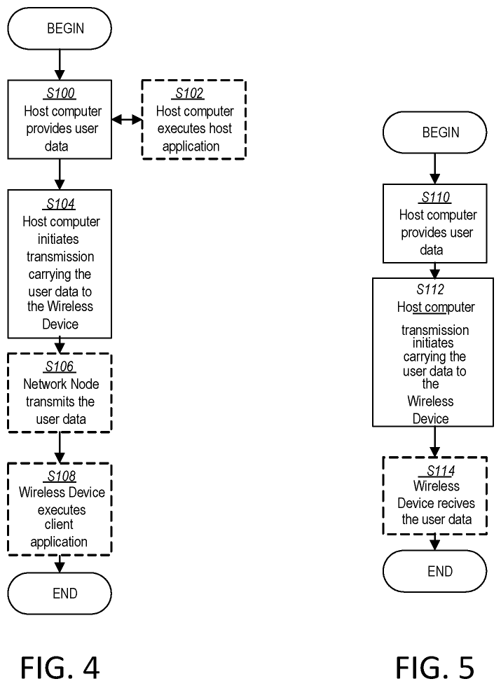

FIG. 4 is a flowchart illustrating an example method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

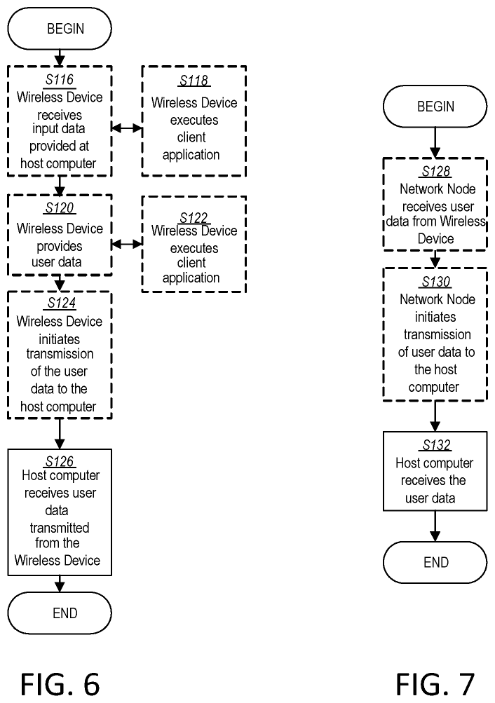

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 8 is a flowchart of an example process in a network node 16 according to some embodiments of the present disclosure. One or more Blocks and/or functions and/or methods performed by the network node 16 may be performed by one or more elements of network node 16 such as by determination unit 32 in processing circuitry 68, processor 70, radio interface 62, etc. according to the example method. The example method includes determining (Block S134), such as via determination unit 32, processing circuitry 68, processor 70, communication interface 60 and/or radio interface 62, whether to use one of a coherent detection and a non-coherent detection of a physical uplink control channel, PUCCH, based at least in part on information relating to the wireless device. The method includes configuring (Block S136), such as via determination unit 32, processing circuitry 68, processor 70, communication interface 60 and/or radio interface 62, the wireless device 22 with a first sequence and a second sequence for a hybrid automatic repeat request, HARQ, acknowledgement information on the PUCCH based at least in part on the determination of the one of the coherent detection and the non-coherent detection, the first sequence corresponding to a HARQ acknowledgement, HARQ-ACK, and the second sequence corresponding to a HARQ non-acknowledgement, HARQ-NACK. The method includes receiving (Block S138), such as via determination unit 32, processing circuitry 68, processor 70, communication interface 60 and/or radio interface 62, the HARQ acknowledgement information on the PUCCH according to the first sequence and the second sequence.

In some embodiments, when the determining comprises determining to use the coherent detection of the PUCCH based at least in part on the information relating to the wireless device, configuring the wireless device 22 with the first sequence and the second sequence includes: configuring, such as via determination unit 32, processing circuitry 68, processor 70, communication interface 60 and/or radio interface 62, the wireless device 22 with the first sequence and the second sequence as partially overlapping sequences. In some embodiments, when the determining comprises determining to use the coherent detection of the PUCCH based at least in part on the information relating to the wireless device, the receiving includes: estimating, such as via determination unit 32, processing circuitry 68, processor 70, communication interface 60 and/or radio interface 62, a part of the PUCCH in which the first sequence partially overlaps with the second sequence and using the channel estimation to decode the HARQ acknowledgement information on the PUCCH.

In some embodiments, when the determining comprises determining to use the coherent detection of the PUCCH based at least in part on the information relating to the wireless device, the receiving includes: estimating, such as via determination unit 32, processing circuitry 68, processor 70, communication interface 60 and/or radio interface 62, the PUCCH based on an overlap of the first sequence and the second sequence and interpolating the channel estimation to at least one resource element in which the first sequence and the second sequence do not overlap. In some embodiments, when the determining comprises determining to use the non-coherent detection of the PUCCH based at least in part on the information relating to the wireless device 22, the receiving includes: correlating, such as via determination unit 32, processing circuitry 68, processor 70, communication interface 60 and/or radio interface 62, the received HARQ acknowledgment information to the first sequence and the second sequence to determine whether the HARQ acknowledgment information is a HARQ acknowledgement, ACK, corresponding to the first sequence or a HARQ non-acknowledgement, NACK, corresponding to the second sequence.

In some embodiments, the configuration of the wireless device 22 with the first sequence and the second sequence is a configuration of the PUCCH with a physical uplink control channel format 0. In some embodiments, the configuring of the wireless device 22 includes configuring the wireless device 22 via radio resource control, RRC, signaling. In some embodiments, the determining whether to use the one of the coherent detection and the non-coherent detection of the PUCCH based at least in part on the information about the wireless device 22 includes: determining, such as via determination unit 32, processing circuitry 68, processor 70, communication interface 60 and/or radio interface 62, whether to use the one of the coherent detection and the non-coherent detection of the PUCCH based at least in part on a type of service associated with the wireless device 22.

In some embodiments, the type of service corresponds to a type of service for a downlink channel and the HARQ acknowledgement information one of acknowledges and non-acknowledges successful reception of the downlink channel. In some embodiments, the type of service is at least one of an Ultra Reliable Low Latency Communication, URLLC, an enhanced mobile broadband, eMBB, and a massive machine type communication, mMTC. In some embodiments, when the type of service is the URLLC, determining to use the coherent detection for the wireless device 22; and when the type of service is one of the eMBB and the mMTC, determining to use the non-coherent detection for the wireless device 22.

In some embodiments, the determining to use one of the coherent detection and the non-coherent detection of the PUCCH based at least in part on the information about the wireless device 22 includes: determining, such as via determination unit 32, processing circuitry 68, processor 70, communication interface 60 and/or radio interface 62, whether to use the one of the coherent detection and the non-coherent detection of the PUCCH based at least in part on a location of the wireless device 22 within a cell supported by the network node 16 relative to a location of the network node 16. In some embodiments, the determining to use one of the coherent detection and the non-coherent detection of the PUCCH based at least in part on the information about the wireless device 22 comprises: determining, such as via determination unit 32, processing circuitry 68, processor 70, communication interface 60 and/or radio interface 62, whether to use the one of the coherent detection and the non-coherent detection of the PUCCH based at least in part on a geometry associated with the wireless device 22.

In some embodiments, the determining to use the one of the coherent detection and the non-coherent detection of the PUCCH based at least in part on the information about the wireless device 22 includes: determining, such as via determination unit 32, processing circuitry 68, processor 70, communication interface 60 and/or radio interface 62, whether to use the one of the coherent detection and the non-coherent detection of the PUCCH based at least in part on a signal-to-interference-plus-noise-ratio, SINR, associated with the wireless device over a period of time. In some embodiments, the determining whether to use the one of the coherent detection and the non-coherent detection of the PUCCH based at least in part on the information about the wireless device 22 includes: determining, such as via determination unit 32, processing circuitry 68, processor 70, communication interface 60 and/or radio interface 62, whether to use the one of the coherent detection and the non-coherent detection of the PUCCH based at least in part on a path loss associated with the wireless device 22 to the network node 16.

In some embodiments, the method further includes transmitting a downlink data channel to the wireless device; and the HARQ acknowledgement information one of acknowledges and non-acknowledges successful reception of the downlink data channel based on whether the HARQ acknowledgement information uses the first sequence or the second sequence. In some embodiments, the first sequence and the second sequence are constant amplitude zero autocorrelation, CAZAC, complex value symbols.

FIG. 9 is a flowchart of an example process in a wireless device 22 according to some embodiments of the present disclosure. One or more Blocks and/or functions and/or methods performed by WD 22 may be performed by one or more elements of WD 22 such as by HARQ unit 34 in processing circuitry 84, processor 86, radio interface 82, etc. The example method includes receiving (Block S140), such as via HARQ unit 34, processing circuitry 84, processor 86 and/or radio interface 82, a configuration of a first sequence and a second sequence for a hybrid automatic repeat request, HARQ, acknowledgement information on a physical uplink control channel, PUCCH, the configuration of the first sequence and the second sequence being based at least in part on a determination of whether to use one of a coherent detection and a non-coherent detection of the PUCCH, the first sequence corresponding to a HARQ acknowledgement, HARQ-ACK, and the second sequence corresponds to a HARQ non-acknowledgement, HARQ-NACK. The method includes sending (Block S142), such as via HARQ unit 34, processing circuitry 84, processor 86 and/or radio interface 82, the HARQ acknowledgement information on the PUCCH according to the configuration of the first sequence and the second sequence.

In some embodiments, when the determination is to use the coherent detection of the PUCCH, receiving, such as via HARQ unit 34, processing circuitry 84, processor 86 and/or radio interface 82, the configuration of the first sequence and the second sequence includes: receiving the configuration having the first sequence and the second sequence as partially overlapping sequences. In some embodiments, when the determination is to use the coherent detection of the PUCCH, the sending includes: sending, such as via HARQ unit 34, processing circuitry 84, processor 86 and/or radio interface 82, the HARQ acknowledgement information on the PUCCH, a part of the PUCCH in which the first sequence overlaps with the second sequence corresponding to a reference signal to be used to estimate the PUCCH for decoding the HARQ acknowledgement information.

In some embodiments, the configuration of the first sequence and the second sequence is a configuration of the PUCCH with a physical uplink control channel format 0. In some embodiments, the configuration of the first sequence and the second sequence is performed via radio resource control, RRC, signaling. In some embodiments, the determination of whether to use the one of the coherent detection and the non-coherent detection of the PUCCH is based at least in part on information about the wireless device 22. In some embodiments, the information includes a type of service associated with the wireless device 22. In some embodiments, the type of service corresponds to a type of service for a downlink channel and the HARQ acknowledgement information one of acknowledges and non-acknowledges successful reception of the downlink channel.

In some embodiments, the type of service is at least one of an Ultra Reliable Low Latency Communication, URLLC, an enhanced mobile broadband, eMBB, and a massive machine type communication, mMTC; when the type of service is the URLLC, the configuration of the first sequence and the second sequence is for coherent detection; and when the type of service is one of the eMBB and mMTC, the configuration of the first sequence and the second sequence is for non-coherent detection. In some embodiments, the information includes a location of the wireless device 22 within a cell supported by the network node 16 relative to a location of the network node 16. In some embodiments, the information includes a geometry associated with the wireless device 22. In some embodiments, the information includes a signal-to-interference-plus-noise-ratio, SINR, associated with the wireless device 22 over a period of time.

In some embodiments, the information includes a path loss associated with the wireless device 22 to the network node 16. In some embodiments, the method further includes receiving, such as via HARQ unit 34, processing circuitry 84, processor 86 and/or radio interface 82, a downlink data channel; and the HARQ acknowledgment information one of acknowledges and non-acknowledges successful reception of the downlink data channel based on whether the HARQ acknowledgment information uses the first sequence or the second sequence. In some embodiments, the first sequence and the second sequence are constant amplitude zero autocorrelation, CAZAC, complex value symbols.

Having described the general process flow of arrangements of the disclosure and having provided examples of hardware and software arrangements for implementing the processes and functions of the disclosure, the sections below provide details and examples of arrangements for decoding short physical uplink control channel such as for Ultra-Reliable Low Latency Communication (URLLC), which may be implemented by the network node 16, wireless device 22 and/or host computer 24.

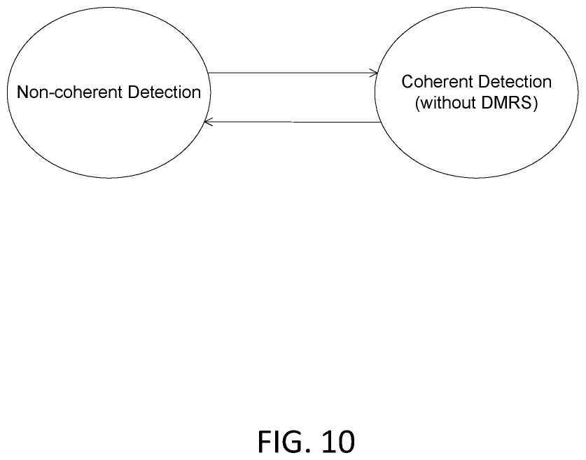

Some embodiments provide for a robust PUCCH detection mechanism without increasing the complexity at the network. Some embodiments provide for a hybrid detection scheme, which includes a coherent-detection (without adding DMRS) and a non-coherent detection, as illustrated in the block diagram shown in FIG. 10.

Non-Coherent Detection

In this detection scheme, the network node 16 may use a correlation detection scheme, where the network node 16 uses a HARQ-ACK sequence and a HARQ-NAK sequence which are correlated with the received signal and chooses the sequence that gives the better correlation. Mathematically, the received signal by the network node 16 can be written as, for example:

Y=Hx+n,

where Y is the received signal, H is the channel matrix, x is the transmitted HARQ-ACK/HARQ-NAK and n is the noise plus interference. With a correlation-based detector (for example PUCCH format 0), the network node 16 may use the following criteria to determine the HARQ-ACK or HARQ-NAK. Let,

Z_{ack}=x_{ack}^{h}Y,

where x_{ack}^{h} is the complex conjugate of the HARQ-ACK sequence and Z_{ack} is the detected sequence after correlating with the HARQ-ACK sequence. Similarly,

Z_{Nack}=x_{Nack}^{h}Y

where x_{Nack}^{h} is the complex conjugate of the HARQ-NACK sequence and Z_{Nack} is the detected sequence after correlating with HARQ-NACK sequence. Then, the network node 16 determines the final outcome as HARQ-ACK only when, for example:

Z_{ack}>Z_{Nack}.

Coherent Detection without DMRS

Note that in non-coherent detection, the network node 16 does not require any channel estimation since the network node 16 correlates the received signal with the HARQ-ACK and HARQ-NAK. However, if the network node 16 knows the channel between the WD 22 and the network node 16 (e.g., such as via channel estimation), then the network node 16 can perform coherent detection on the received signal (PUCCH transmission e.g., PUCCH format 0) to determine whether the received signal is a HARQ-ACK or HARQ-NAK. One way to estimate the channel is to introduce reference signals to the payload. However, since a short PUCCH is configured for either 1 orthogonal frequency division multiplexing (OFDM) symbol or OFDM 2 symbols, adding reference signals introduces additional overhead. However, if the network node 16 configures the sequences such that there is a partial overlap in the sequences between the HARQ-ACK and HARQ-NAK, then the network node 16 can use these overlapping symbols to estimate the channel between the WD 22 and the network node 16. Once the channel is known at the network node 16 via the channel estimation, the network node 16 can then use a conventional detection, such as maximum likelihood or minimum mean square error (MMSE), Interference Rejection Combining (IRC), Maximum Ratio Combining (MRC), etc. to determine the HARQ-ACK or HARQ-NAK from the received signal.

In one example, the CAZAC sequence used for HARQ-ACK includes the following CAZAC complex value symbols:

[−0.7071−0.7071i
−0.9659+0.2588i
0.9659+0.2588i
0.7071−0.7071i
−0.2588−0.9659i
0.9659+0.2588i
−0.7071−0.7071i
0.9659−0.2588i
0.2588−0.9659i
0.7071+0.7071i
−0.9659+0.2588i
−0.9659−0.2588i];
   and the CAZAC sequence used for HARQ-NAK includes the following CAZAC complex value symbols:
   [−0.7071−0.7071i
0.9659−0.2588i
0.9659+0.2588i
−0.7071+0.7071i
−0.2588−0.9659i
−0.9659−0.2588i
−0.7071−0.7071i
−0.9659+0.2588i
0.2588−0.9659i
−0.7071−0.7071i
−0.9659+0.2588i
0.9659+0.2588i].

Observe that, in this example, the sequence length is equal to 12 (1 OFDM) symbol). Note that NR specification allows a sequence length equal to 24 (2 OFDM symbols). Observe that both the sequences have the same elements (complex values) for complex values 1, 3, 5, 7, 9 and 11 (bolded in the complex value list above). Hence, the network node 16 may use these known (e.g., predetermined, configured, etc.) values (which are common to both the HARQ-ACK and HARQ-NACK sequences) in order to estimate the channel between the WD 22 and the network node 16 on the resource elements (REs) of the known overlapping sequence elements/parts. After the network node 16 estimates the channel on the known sequence (i.e., the partially overlapping sequences, in other words, the parts of the HARQ-ACK and HARQ-NACK sequences that are overlapping/common), the network node 16 may use extrapolation or interpolation on the unknown sequence resource elements to estimate the channel. When the channel is estimated, the network node 16 may use a conventional, such as Maximum likelihood, MMSE, IRC or MRC receiver to determine whether the WD 22 transmitted HARQ-ACK or HARQ-NAK on the PUCCH.

In some embodiments, the partially overlapping sequence means that at least one complex number (and less than all the complex numbers) in the first sequence and the second sequence are the same. In some embodiments, the overlap to non-overlap ratio can be various percentages as discussed, e.g., 50-50, 30-70, 60-40, etc. The non-limiting example described above shows a 50 percent non-overlapping and 50 percent overlapping ratio (i.e., 6 of the 12 elements in the sequence are the same and 6 of the 12 elements are different as between the two sequences).

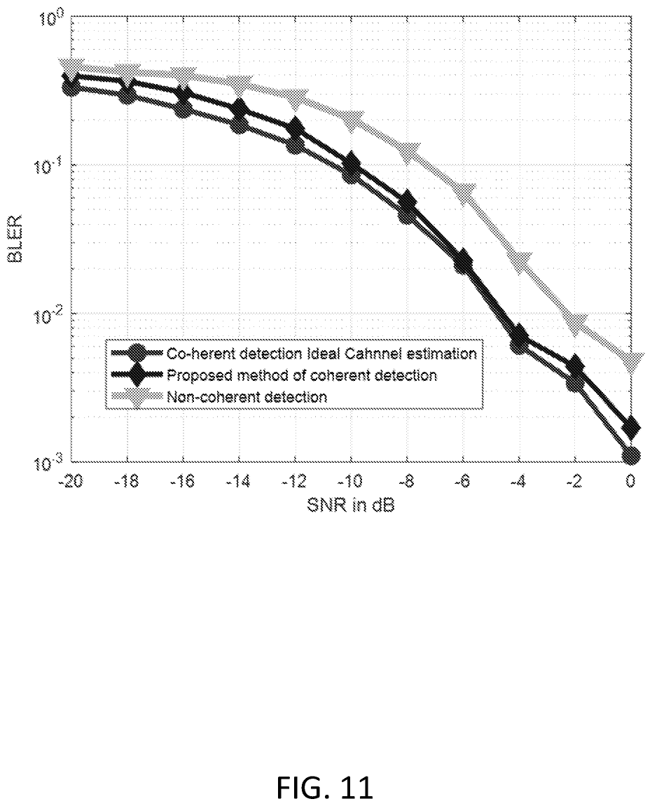

FIG. 11 is a graph showing the BLER performance using an embodiment of the proposed technique. It can be observed from FIG. 11 that there is an almost 2.5 decibel (dB) SNR gain using the proposed technique.

Switching Between Coherent Detection and Non-Coherent Detection

Note that in coherent detection (without adding DMRS), the network node 16 may use a channel estimator to estimate the channel between the WD 22 and the network node 16. To avoid the complexity of including channel estimation and then a detection scheme, in some embodiments, the network node 16 may determine which WDs 22 it can use coherent detection for and which WDs 22 it can use non-coherent detection for. In some embodiments, based on this determination, the network node 16 may configure the WD 22 with parameters such that the sequences have some overlapping symbols.

For example, if the network node 16 determines that it should use coherent PUCCH detection for a particular WD 22 (e.g., a URLLC WD 22), the network node 16 may configure such WD 22 with the partially overlapping sequences introduced in this disclosure. On the other hand, if the network node 16 determines that it can get away with using non-coherent PUCCH detection for another WD 22 (e.g., eMBB WD 22), the network node 16 may configure that WD 22 without regard to overlapping sequences. In some embodiments, the network node's 16 use of coherent versus non-coherent detection for PUCCH may be considered transparent to the WD 22 in that the WD 22 may not be aware of which PUCCH detection mechanism that the network node 16 uses, but rather may receive the configuration from the network node 16 and then transmit the PUCCH according to the received configuration.

Some examples of performance specific criteria that the network node 16 may use in selecting the appropriate receiver (e.g., coherent detection receiver and non-coherent detection receiver) for receiving a PUCCH transmission may include one or more of:
Type of service (e.g., URLLC, eMBB, mMTC, etc.) for the WD 22;
WD 22 location in the cell;
Geometry or long term signal-to-interference-plus-noise ratio (SINR) of the WD 22; and
Combination of criteria.

Type of Service

Note that if the network node 16 schedules a WD 22 with URLLC type of services, the network node 16 may be expected to detect PUCCH with high reliability and low latency. Hence, in these cases, the network node 16 may use the coherent based detection scheme for detecting PUCCH from that WD 22, while for eMBB or mMTC WD's, the network node 16 may use the non-coherent detection scheme.

WD Location in the Cell

One criteria for determining which receiver the network node 16 is to use to receive PUCCH from a WD 22 may include identifying the location of the WD 22 in the cell. For example, when the WD 22 is nearer to the network node 16 (or a relatively stationary WD 22 located in a small cell), the network node 16 may use non-coherent detection. This may be because at the cell center the WD 22 generally is at a high SNR. Similarly, when the WD 22 is at the cell edge, the network node 16 may determine to use coherent detection, since the cell edge WDs 22 generally have low SNRs.

Note that there are several methods to identify the WD 22 location from network node 16. For example, the WD 22 location in the WD 22 may be determined using one or more positioning methods and/or signals measurements used for radio operations. Examples of positioning methods and corresponding measurements are Global Navigation Satellite Systems (GNSS) (e.g. Global Positioning System) measurements, enhanced cell ID (E-CID) measurements, such as WD 22 or base station Receive-Transmit (Rx-Tx) time difference measurements, timing advance (TA), angle of arrival (AoA), observed time difference of arrival (OTDOA) reference signal time difference (RSTD), etc. Examples of signal measurements used for radio operations are the reported channel quality indicators (CQIs), measurements used for the mobility such as RSRP and RSRQ measurement reports, etc. The size of the neighbor cell list (NCL) for the WD 22 may also be an indication of whether the WD 22 is at the cell center or not. For example, if serving cell's RSRP is below a threshold (e.g., −100 dBm) then the network node 16 may assume that the WD 22 is in the cell border/edge. Other techniques for determining the location of the WD 22 within the cell may be used in some embodiments.

WD Geometry

Instead of, or in addition to, using the location of the WD 22, the network node 16 may use the geometry of the WD 22 for choosing the receiver (e.g., coherent receiver or non-coherent receiver). At low geometries (e.g., lower SINR) the network node 16 may use the coherent detection scheme. At high geometries (e.g. higher SINR) the network node 16 may choose the non-coherent detection scheme.

Note that the geometry of the WD 22 may be computed by averaging the SINR, for example, using uplink channel estimates, or by averaging the CQI reported by the WD 22. Other techniques for computing the geometry of the WD 22 may be used in some embodiments.

Combination of the Criteria

Any combination of two or more criteria described above, as well as, other criteria may be used by the network node 16 for determining which receiver to use to receive the PUCCH from a particular WD 22.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| AMC | Adaptive Modulation and Coding |
| CQI | Channel Quality Indicator |
| HARQ | Hybrid Automatic Repeat Request |
| ACK | Acknowledgement |
| NACK | Negative-Acknowledgement |
| PDSCH | Physical Downlink shared channel |
| PUSCH | Physical Uplink Shared Channel |
| PUCCH | Physical uplink control channel |
| Tx | Transmitter |
| UE | User Equipment |
| BS | Base Station |
| gNB | generalized Node B base station |
| E-UTRA | Evolved universal terrestrial radio access network |
| E-UTRA | Evolved universal terrestrial radio access |
| E-UTRA FDD | E-UTRA frequency division duplex |
| E-UTRA TDD | E-UTRA time division duplex |
| NR | New Radio |
| LTE | Long term evolution |
| RAT | Radio Access Technology |
| SINR | Signal-to-Interference Ratio |
| URLLC | Ultra-Reliable Low Latency Communication |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a network node for detection of a signal received from a wireless device, the method comprising:
determining whether to use one of a coherent detection and a non-coherent detection of a physical uplink control channel (PUCCH), PUCCH, based at least in part on information relating to the wireless device;
configuring the wireless device with a first sequence and a second sequence for a hybrid automatic repeat request (HARQ), HARQ, acknowledgement information on the PUCCH based at least in part on the determination of the one of the coherent detection and the non-coherent detection, the first sequence corresponding to a HARQ acknowledgement (HARQ-ACK), and the second sequence corresponding to a HARQ non-acknowledgement (HARQ-NACK); and
receiving the HARQ acknowledgement information on the PUCCH according to the first sequence and the second sequence.

2. The method of claim 1, wherein when the determining comprises determining to use the coherent detection of the PUCCH based at least in part on the information relating to the wireless device, configuring the wireless device with the first sequence and the second sequence comprises:
configuring the wireless device with the first sequence and the second sequence as partially overlapping sequences.

3. The method of claim 1, wherein when the determining comprises determining to use the coherent detection of the PUCCH based at least in part on the information relating to the wireless device, the receiving comprises:
estimating a part of the PUCCH in which the first sequence partially overlaps with the second sequence and using the channel estimation to decode the HARQ acknowledgement information on the PUCCH.

4. The method of claim 1, wherein when the determining comprises determining to use the coherent detection of the PUCCH based at least in part on the information relating to the wireless device, the receiving comprises:
estimating the PUCCH based on an overlap of the first sequence and the second sequence and interpolating the channel estimation to at least one resource element in which the first sequence and the second sequence do not overlap.

5. The method of claim 1, wherein when the determining comprises determining to use the non-coherent detection of the PUCCH based at least in part on the information relating to the wireless device, the receiving comprises:
correlating the received HARQ acknowledgment information to the first sequence and the second sequence to determine whether the HARQ acknowledgment information is the HARQ acknowledgement (ACK) corresponding to the first sequence or the HARQ non-acknowledgement (NACK) corresponding to the second sequence.

6. The method of claim 1, wherein the configuration of the wireless device with the first sequence and the second sequence is a configuration of the PUCCH with a physical uplink control channel format 0.

7. The method of claim 1, wherein the configuring of the wireless device includes configuring the wireless device via radio resource control (RRC), RRC, signaling.

8. The method of claim 1, wherein the determining whether to use the one of the coherent detection and the non-coherent detection of the PUCCH based at least in part on the information about the wireless device comprises:
determining whether to use the one of the coherent detection and the non-coherent detection of the PUCCH based at least in part on a type of service associated with the wireless device.

9. The method of claim 8, wherein the type of service corresponds to a type of service for a downlink channel and the HARQ acknowledgement information one of acknowledges and non-acknowledges successful reception of the downlink channel.

10. The method of claim 8, wherein:
the type of service is at least one of an Ultra Reliable Low Latency Communication (URLLC), an enhanced mobile broadband (eMBB), and a massive machine type communication (mMTC);
when the type of service is the URLLC, determining to use the coherent detection for the wireless device; and
when the type of service is one of the eMBB and the mMTC, determining to use the non-coherent detection for the wireless device.

11. The method of claim 1, wherein the determining to use one of the coherent detection and the non-coherent detection of the PUCCH based at least in part on the information about the wireless device comprises:
determining whether to use the one of the coherent detection and the non-coherent detection of the PUCCH based at least in part on a location of the wireless device within a cell supported by the network node relative to a location of the network node.

12. The method of claim 1, wherein the determining to use one of the coherent detection and the non-coherent detection of the PUCCH based at least in part on the information about the wireless device comprises:
determining whether to use the one of the coherent detection and the non-coherent detection of the PUCCH based at least in part on a geometry associated with the wireless device.

13. The method of claim 1, wherein the determining to use the one of the coherent detection and the non-coherent detection of the PUCCH based at least in part on the information about the wireless device comprises:
determining whether to use the one of the coherent detection and the non-coherent detection of the PUCCH based at least in part on a signal-to-interference-plus-noise-ratio (SINR) associated with the wireless device over a period of time.

14. The method of claim 1, wherein the determining whether to use the one of the coherent detection and the non-coherent detection of the PUCCH based at least in part on the information about the wireless device comprises:
determining whether to use the one of the coherent detection and the non-coherent detection of the PUCCH based at least in part on a path loss associated with the wireless device to the network node.

15. The method of claim 1, further comprising:
transmitting a downlink data channel to the wireless device,
wherein the HARQ acknowledgement information one of acknowledges and non-acknowledges successful reception of the downlink data channel based on whether the HARQ acknowledgement information uses the first sequence or the second sequence.

16. The method of claim 1, wherein the first sequence and the second sequence are constant amplitude zero autocorrelation (CAZAC) complex value symbols.

17. A method implemented in a wireless device configured to communicate with a network node, the method comprising:
receiving a configuration of a first sequence and a second sequence for a hybrid automatic repeat request (HARQ) acknowledgement information on a physical uplink control channel (PUCCH) the configuration of the first sequence and the second sequence is based at least in part on a determination of whether to use one of a coherent detection and a non-coherent detection of the PUCCH, the first sequence corresponding to a HARQ acknowledgement (HARQ-ACK) and the second sequence corresponds to a HARQ non-acknowledgement (HARQ-NACK); and
sending the HARQ acknowledgement information on the PUCCH according to the configuration of the first sequence and the second sequence.

18. The method of claim 17, wherein when the determination is to use the coherent detection of the PUCCH, receiving the configuration of the first sequence and the second sequence comprises:
receiving the configuration having the first sequence and the second sequence as partially overlapping sequences.

19. The method of claim 17, wherein when the determination is to use the coherent detection of the PUCCH, the sending comprises:
sending the HARQ acknowledgement information on the PUCCH, a part of the PUCCH in which the first sequence overlaps with the second sequence corresponding to a reference signal to be used to estimate the PUCCH for decoding the HARQ acknowledgement information.

20. The method of claim 17, wherein the configuration of the first sequence and the second sequence is a configuration of the PUCCH with a physical uplink control channel format 0.

21-62. (canceled)
